(19) United States
(12) Patent Application Publication
(10) Pub. No.: US 2009/0185518 A1
(43) Pub. Date: Jul. 23, 2009

(54) SYSTEM AND METHOD TO ENABLE BASE STATION POWER SETTING BASED ON NEIGHBORING BEACONS WITHIN A NETWORK

(75) Inventor: Pramod Viswanath, Urbania, IL (US)

Correspondence Address: QUAI.COMM Incorporated.;Patent Department/Central Administration., 5775 Morehouse Drive., San Diego, CA, 92121-1714, US

(73) Assignee: QUALCOMM Incorporated, San Diego, CA (US)

(21) Appl. No.: 12/353,092

(22) Filed: Jan. 13, 2009

Related U.S. Application Data
(60) Provisional application No. 61/021,767, filed on Jan. 17, 2008.

(51) Int. Cl. G08C 17/00

(52) U.S. Cl. 370/311

(57) ABSTRACT

Systems and methods for facilitating power control in an access point are provided. Disclosed embodiments include detecting the presence of a neighboring access point that is within radio reach of the access point. A signal strength corresponding to the neighboring access point is ascertained such that the neighboring signal strength is a function of the transmission power of the neighboring access point. The transmission power of the access point is then varied as a function of the neighboring signal strength.

### CROSS-REFERENCE TO RELATED APPLICATIONS

This application claims the benefit of U.S. Provisional Patent application Ser. No. 61/021,767 entitled “SYSTEM AND METHOD TO ENABLE BASE STATION POWER SETTING BASED ON NEIGHBORING BEACONS WITHIN A NETWORK,” which was filed Jan. 17, 2008.

### BACKGROUND

I. Field

The following description relates generally to wireless communications, and more particularly to a system and method for enabling a base station power setting based on neighboring beacons within a network.

II. Background

Wireless communication systems are widely deployed to provide various types of communication; for instance, voice and/or data can be provided via such wireless communication systems. A typical wireless communication system, or network, can provide multiple users access to one or more shared resources (e.g., bandwidth, transmit power, etc.). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), High Speed Packet (HSPA, HSPA+), and others. Moreover, wireless communication systems can be designed to implement one or more standards, such as IS-95, CDMA2000, IS-856, W-CDMA, TD-SCDMA, and the like.

In designing a reliable wireless communication system, special attention must be given to particular data transmission parameters. For instance, in a conventional wireless communication system, a base station power is hard-set based on a detailed knowledge of the topology where it is installed (e.g., the power is generally lower in dense metropolitan areas in order to relieve congestion, as compared to rural sparse areas where the goal may primarily be to provide coverage). Inter-cell interference is thus managed by the careful choice of transmit power. In plug-and-play networks, such as 802.11, the power is also hard-set. This can lead to serious interference problems when more 802.11 base stations are set up. Accordingly, it would be desirable to have a method and system for mitigating potential interference from neighboring base stations in a wireless environment.

The above-described deficiencies of current wireless communication systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating adapting a base station's power according to the varying interference topology of its wireless environment. Such embodiments may, for example, include having the base station periodically “listen” in the downlink so as to monitor neighboring transmissions.

In one aspect, a method for facilitating power control in an access point is provided. Within such embodiment, the presence of a neighboring access point that is within radio reach of the access point is detected. A signal strength corresponding to the neighboring access point is ascertained such that the neighboring signal strength is a function of the transmission power of the neighboring access point. The transmission power of the access point is then varied as a function of the neighboring signal strength.

In another aspect, a system for facilitating power control in an access point is provided. Within such embodiment, a processor component is coupled to an interface component, a memory component, and a power control component. The interface component is configured to determine the presence a neighboring access point accessible to the access point via a radio communication. In this embodiment, the processing component is configured to execute computer-readable instructions, and the memory component is configured to store the computer-readable instructions. The instructions include instructions for determining the signal strength of the neighboring access point, where the signal strength is proportional to the transmission power of the neighboring access point. The power control component is then configured to adjust the transmission power of the access point as a function of the neighboring signal strength.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 illustrates an exemplary wireless communication system.

FIG. 2. illustrates an exemplary communication system to enable deployment of access point base stations within a network environment.

FIG. 3 is an illustration of an example wireless network environment that can be employed in conjunction with the various systems and methods described herein.

FIG. 4 illustrates an exemplary interference topology.

FIG. 5 illustrates a block diagram of an exemplary system that facilitates varying the transmission power of an access point in accordance with an aspect of the subject specification.

FIG. 6 is an illustration of an exemplary coupling of electrical components that effectuate varying the transmission power of an access point in accordance with an aspect of the subject specification.

FIG. 7 illustrates a block diagram of an exemplary system that facilitates varying the transmission power of an access point from sensory data.

FIG. 8 is a flow chart illustrating an exemplary methodology for varying the transmission power of an access point from a broadcast signal.

FIG. 9 is an illustration of an exemplary communication system implemented in accordance with various aspects including multiple cells.

FIG. 10 is an illustration of an exemplary base station in accordance with various aspects described herein.

FIG. 11 is an illustration of an exemplary wireless terminal implemented in accordance with various aspects described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA), High Speed Packet Access (HSPA), and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

High speed packet access (HSPA) can include high speed downlink packet access (HSDPA) technology and high speed uplink packet access (HSUPA) or enhanced uplink (EUL) technology and can also include HSPA+ technology. HSDPA, HSUPA and HSPA+ are part of the Third Generation Partnership Project (3GPP) specifications Release 5, Release 6, and Release 7, respectively.

High speed downlink packet access (HSDPA) optimizes data transmission from the network to the user equipment (UE). As used herein, transmission from the network to the user equipment UE can be referred to as the “downlink” (DL). Transmission methods can allow data rates of several Mbits/s. High speed downlink packet access (HSDPA) can increase the capacity of mobile radio networks. High speed uplink packet access (HSUPA) can optimize data transmission from the terminal to the network. As used herein, transmissions from the terminal to the network can be referred to as the “uplink” (UL). Uplink data transmission methods can allow data rates of several Mbit/s. HSPA+ provides even further improvements both in the uplink and downlink as specified in Release 7 of the 3GPP specification. High speed packet access (HSPA) methods typically allow for faster interactions between the downlink and the uplink in data services transmitting large volumes of data, for instance Voice over IP (VoIP), videoconferencing and mobile office applications

Fast data transmission protocols such as hybrid automatic repeat request, (HARQ) can be used on the uplink and downlink. Such protocols, such as hybrid automatic repeat request (HARQ), allow a recipient to automatically request retransmission of a packet that might have been received in error.

Various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB) or some other terminology.

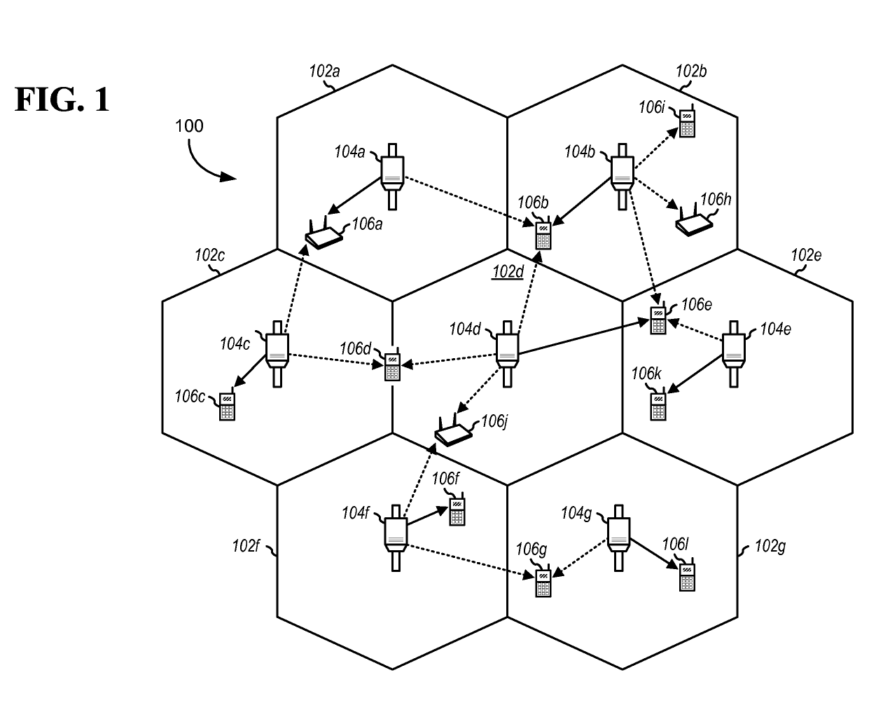

FIG. 1 illustrates an exemplary wireless communication system 100 configured to support a number of users, in which various disclosed embodiments and aspects may be implemented. As shown in FIG. 1, by way of example, system 100 provides communication for multiple cells 102, such as, for example, macro cells 102a-102g, with each cell being serviced by a corresponding access point (AP) 104 (such as APs 104a-104g). Each cell may be further divided into one or more sectors. Various access terminals (ATs) 106, including ATs 106a-106k, also known interchangeably as user equipment (UE), are dispersed throughout the system. Each AT 106 may communicate with one or more APs 104 on a forward link (FL) and/or a reverse link (RL) at a given moment, depending upon whether the AT is active and whether it is in soft handoff, for example. The wireless communication system 100 may provide service over a large geographic region, for example, macro cells 102a-102g may cover a few blocks in a neighborhood.

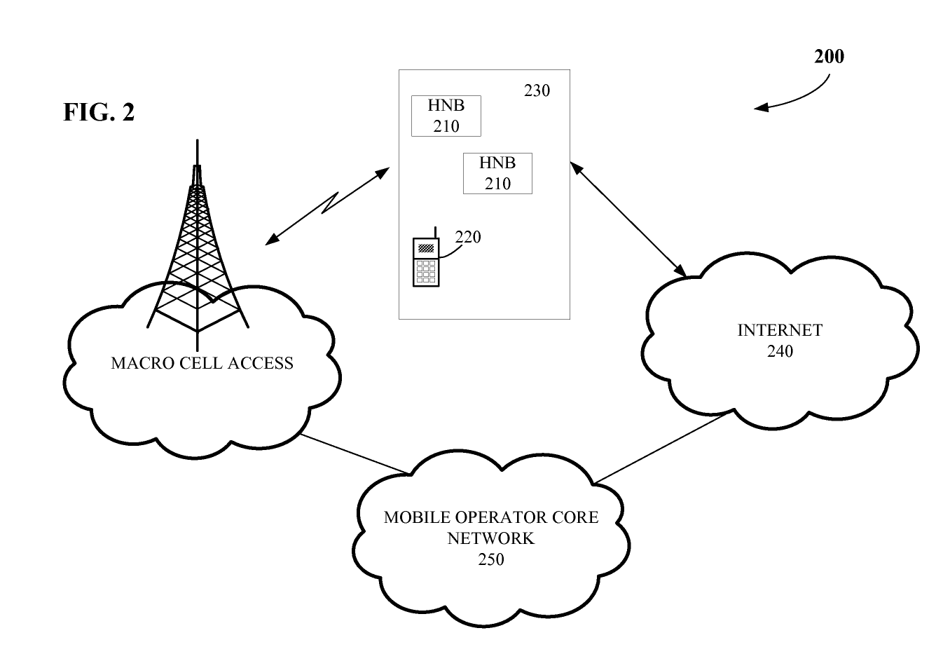

FIG. 2 illustrates an exemplary communication system to enable deployment of access point base stations within a network environment. As shown in FIG. 2, the system 200 includes multiple access point base stations or Home Node B units (HNBs), such as, for example, HNBs 210, each being installed in a corresponding small scale network environment, such as, for example, in one or more user residences 230, and being configured to serve associated, as well as alien, user equipment (UE) 220. Each HNB 210 is further coupled to the Internet 240 and a mobile operator core network 250 via a DSL router (not shown) or, alternatively, a cable modem (not shown).

Although embodiments described herein use 3GPP terminology, it is to be understood that the embodiments may be applied to 3GPP (Re199, Re15, Re16, Re17) technology, as well as 3GPP2 (1×RTT, 1×EV-DO Re10, RevA, RevB) technology and other known and related technologies. In such embodiments described herein, the owner of the HNB 210 subscribes to mobile service, such as, for example, 3G mobile service, offered through the mobile operator core network 250, and the UE 220 is capable to operate both in macro cellular environment and in residential small scale network environment.

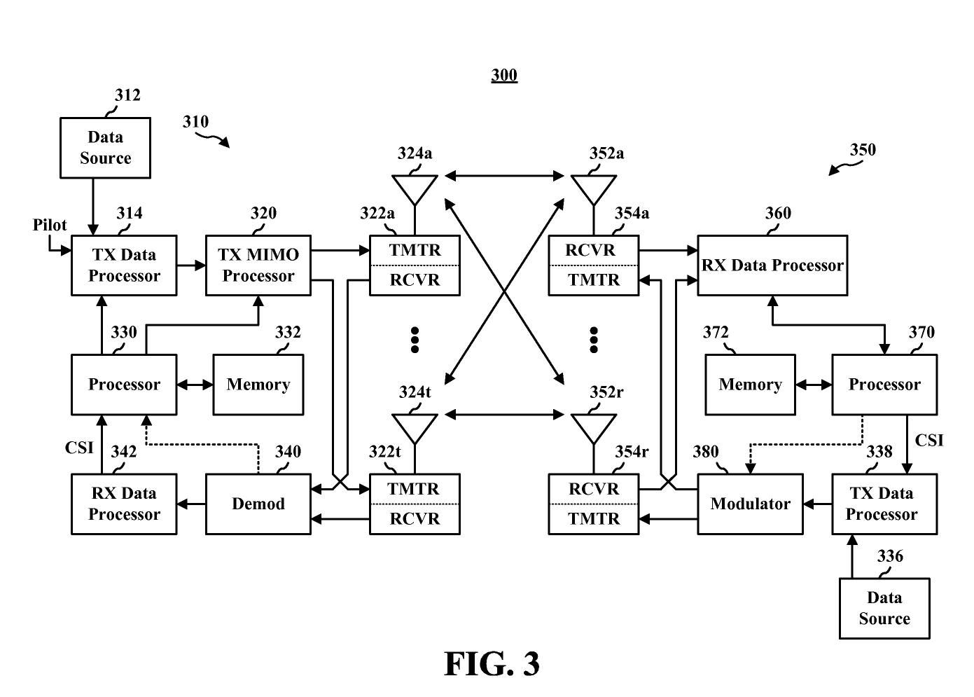

Referring next to FIG. 3, an exemplary wireless communication system 300 is provided. The wireless communication system 300 depicts one base station 310 and one access terminal 350 for sake of brevity. However, it is to be appreciated that system 300 can include more than one base station and/or more than one access terminal, wherein additional base stations and/or access terminals can be substantially similar or different from example base station 310 and access terminal 350 described below. In addition, it is to be appreciated that base station 310 and/or access terminal 350 can employ the systems and/or methods described herein to facilitate wireless communication there between.

At base station 310, traffic data for a number of data streams is provided from a data source 312 to a transmit (TX) data processor 314. According to an example, each data stream can be transmitted over a respective antenna. TX data processor 314 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 350 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 330.

The modulation symbols for the data streams can be provided to a TX MIMO processor 320, which can further process the modulation symbols (e.g., for OFDM). TX MIMO processor 320 then provides N_{T} modulation symbol streams to N_{T} transmitters (TMTR) 322a through 322t. In various embodiments, TX MIMO processor 320 applies beamforming weights to the symbols of the data streams and to the antenna from which the symbol is being transmitted.

Each transmitter 322 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 322a through 322t are transmitted from N_{T} antennas 324a through 324t, respectively.

At access terminal 350, the transmitted modulated signals are received by N_{R} antennas 352a through 352r and the received signal from each antenna 352 is provided to a respective receiver (RCVR) 354a through 354r. Each receiver 354 conditions (e.g., filters, amplifies, and downconverts) a respective signal, digitizes the conditioned signal to provide samples, and further processes the samples to provide a corresponding “received” symbol stream.

An RX data processor 360 can receive and process the N_{R} received symbol streams from N_{R} receivers 354 based on a particular receiver processing technique to provide N_{T} “detected” symbol streams. RX data processor 360 can demodulate, deinterleave, and decode each detected symbol stream to recover the traffic data for the data stream. The processing by RX data processor 360 is complementary to that performed by TX MIMO processor 320 and TX data processor 314 at base station 310.

A processor 370 can periodically determine which available technology to utilize as discussed above. Further, processor 370 can formulate a reverse link message comprising a matrix index portion and a rank value portion.

The reverse link message can comprise various types of information regarding the communication link and/or the received data stream. The reverse link message can be processed by a TX data processor 338, which also receives traffic data for a number of data streams from a data source 336, modulated by a modulator 380, conditioned by transmitters 354a through 354r, and transmitted back to base station 310.

At base station 310, the modulated signals from access terminal 350 are received by antennas 324, conditioned by receivers 322, demodulated by a demodulator 340, and processed by a RX data processor 342 to extract the reverse link message transmitted by access terminal 350. Further, processor 330 can process the extracted message to determine which precoding matrix to use for determining the beamforming weights.

Processors 330 and 370 can direct (e.g., control, coordinate, manage, etc.) operation at base station 310 and access terminal 350, respectively. Respective processors 330 and 370 can be associated with memory 332 and 372 that store program codes and data. Processors 330 and 370 can also perform computations to derive frequency and impulse response estimates for the uplink and downlink, respectively.

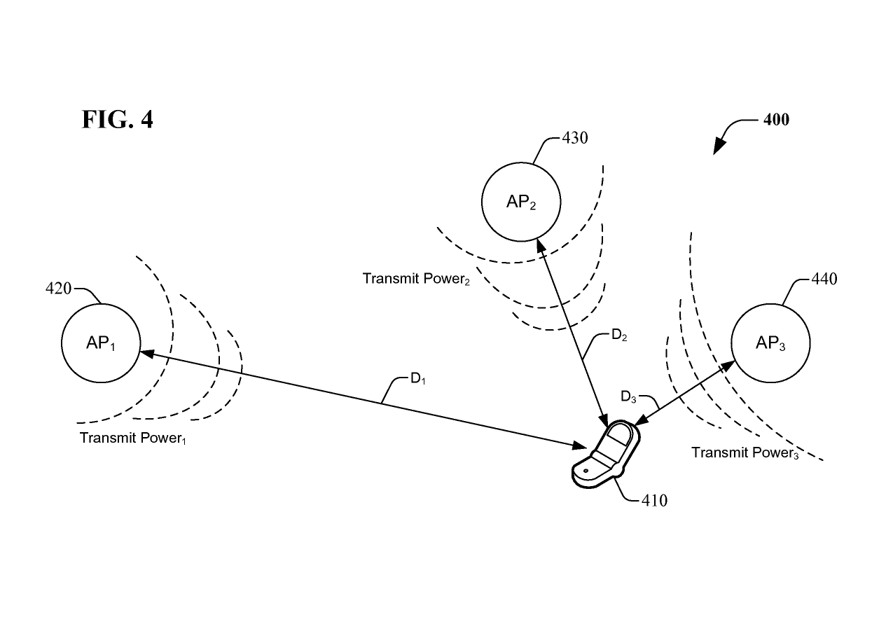

In an embodiment, base station power is adapted as a function of the changing interference topology. Within such embodiment, the base station periodically listens in the downlink so as to monitor neighboring base station transmissions (i.e., transmissions from base stations accessible via radio communication). In FIG. 4, an exemplary system for which any type of access point may monitor such neighboring transmissions is provided.

As illustrated, system 400 may include a plurality of access points, AP₁ 420, AP₂ 430, and AP₃ 440, each of which transmits signals with a particular transmission power. Here, it should be appreciated that, for any location within radio reach of each of AP₁ 420, AP₂ 430, and AP₃ 440, an interference contribution from each of the respective access points will be realized. Each contribution will generally be a function of both the distance between the location and the transmitting access point, as well as the actual transmission power of the access point. For instance, from the perspective of UE 410, the total interference from AP₁ 420, AP₂ 430, and AP₃ 440 may be proportional to

$${\sum }_{i = 1}^{s} \frac{{TransmitPower}_{i}}{{Distance}_{i}}$$

where, TransmitPowerᵢ represents the respective transmission powers for each access point, whereas Distanceᵢ is the respective distance between UE 410 and each of the access points. Accordingly, it should be noted that the access point closest in proximity to a particular location does not necessarily contribute the most interference. For instance, the “received power” at UE 410 from AP₁ 420 may be larger than AP₃ 440 if its transmission power is large enough to overcome the disparity in distance. As such, hereinafter, the “nearest” access point to a particular location will be referred to as the access point providing the largest “received power” at the location.

In an embodiment, in order to mitigate the interference between neighboring access points, either of AP₁ 420, AP₂ 430, and AP₃ 440 may be configured to vary its transmission power according to beacons received from the other access points. Moreover, either of AP₁ 420, AP₂ 430, and AP₃ 440 may be configured to detect a “received power” from any of the other access points, which may then be used to determine a proper transmission power for minimizing interference. For instance, from the perspective of AP₁ 420, if AP₂ 430 is deemed the “nearest” neighboring access point, AP₁ 420 may set its transmission power to half the transmission power of AP₂ 430.

Here, it should be noted that only the received power level of neighboring access points can be measured. Typically, since the transmit power level is some fixed and known constant, there is not much of an issue with calculating the approximate distance. However, for some embodiments, the transmit power is adaptively varying. Thus, alternatively, the transmit power level may also be broadcast (at low enough periodicity so it does not become a serious overhead—envisioning adaptation of transmit power levels very infrequently, for example once in a day).

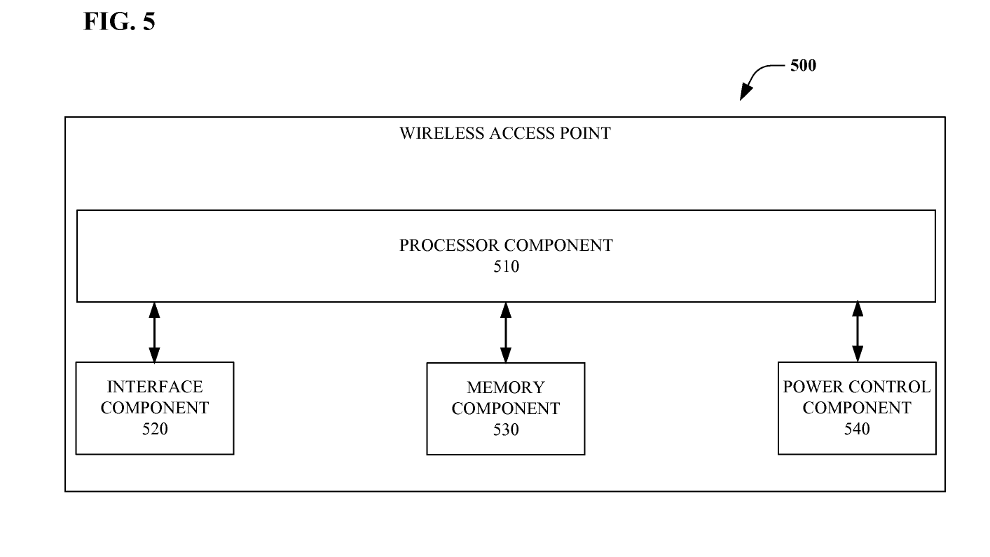

Referring next to FIG. 5, a block diagram of an exemplary access point configured to dynamically vary its transmission power is provided. In an aspect, access point 500 may include processor component 510, interface component 520, memory component 530, and power control unit 540, as shown.

In one aspect, processor component 510 is configured to execute computer-readable instructions related to performing any of a plurality of functions. Processor component 510 can be a single processor or a plurality of processors dedicated to analyzing information to be communicated from access point 500 and/or generating information that can be utilized by interface component 520, memory component 530, and/or power control unit 540. Additionally or alternatively, processor component 510 may be configured to control one or more components of access point 500.

In another aspect, memory component 530 is coupled to processor component 510 and configured to store computer-readable instructions executed by processor component 510. Memory component 530 may also be configured to store any of a plurality of other types of data including lists of base stations having a common association list, as well as data generated by any of processor component 510, interface component 520, and/or power control unit 540. Memory component 530 can be configured in a number of different configurations, including as random access memory, battery-backed memory, hard disk, magnetic tape, etc. Various features can also be implemented upon memory component 530, such as compression and automatic back up (e.g., use of a Redundant Array of Independent Drives configuration).

As illustrated, access point 500 also includes interface component 520. In some aspects, interface component is also coupled to processor component 510 and configured to interface access point 500 with external entities. For instance, interface component 520 may be configured to receive the aforementioned broadcast signals, as well as to include specialized hardware for detecting the received power from neighboring access points. For some embodiments, interface component 520 may also be configured to exchange messages with neighboring access points to facilitate a mutual power agreement that provides a desired interference topology.

In yet another aspect, power control component 540 is coupled to processor component 510 and configured to vary the transmission power of access point 500. Moreover, in an aspect, power control component 540 and processor component 510 work together to ascertain the respective signal strengths of neighboring access points, which are then used to adjust the transmission power of access point 500. It should be noted that power control component 540 may further include a triggering component, which may be utilized to determine when a power adjustment may take place. For instance, power control component 540 may be configured to perform power adjustments before each individual transmission and/or at fixed time intervals. Power control component 540 may also be configured to only perform power adjustments if interface component 520 detects a received power that exceeds a predetermined threshold.

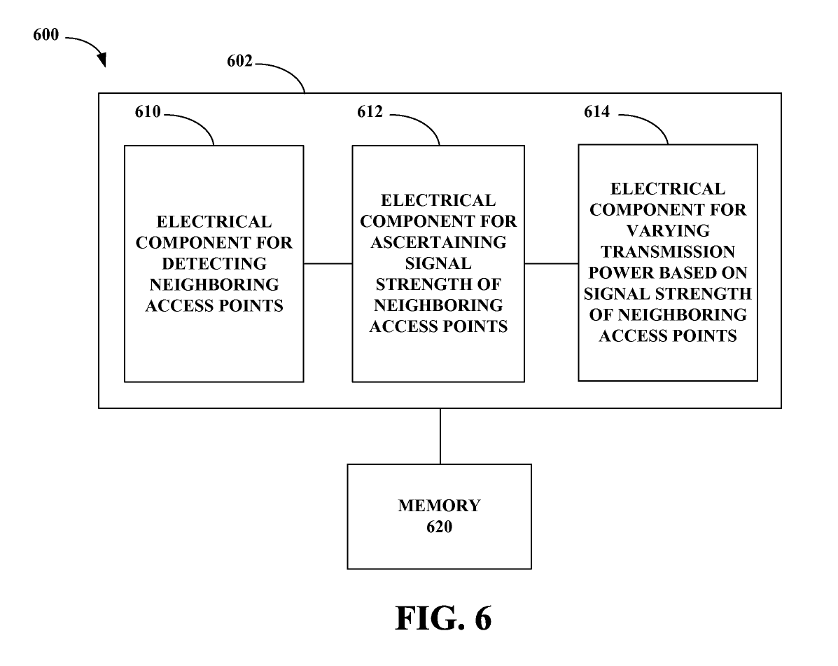

Turning to FIG. 6, illustrated is a system 600 that enables varying the transmission power of an access point in accordance with aspects disclosed herein. System 600 can reside within a base station or wireless terminal, for instance. As depicted, system 600 includes functional blocks that can represent functions implemented by a processor, software, or combination thereof (e.g., firmware). System 600 includes a logical grouping 602 of electrical components that can act in conjunction. As illustrated, logical grouping 602 can include an electrical component for detecting neighboring access points 610. Further, logical grouping 602 can include an electrical component for ascertaining the signal strength of the neighboring access points 612, as well as an electrical component for varying the transmission power of the access point based on the respective signal strengths of the neighboring access points 614. Additionally, system 600 can include a memory 620 that retains instructions for executing functions associated with electrical components 610, 612, and 614. While shown as being external to memory 620, it is to be understood that electrical components 610, 612, and 614 can exist within memory 620.

In the subsequent discussion, particular examples of how the aforementioned method/system for varying transmission power in an access point are provided. In particular, embodiments are provided to show various contemplated combinations for implementing the disclosed subject matter. Here, it should be appreciated that such embodiments are provided for illustrative purposes only and should not be construed as an exhaustive list of potential applications.

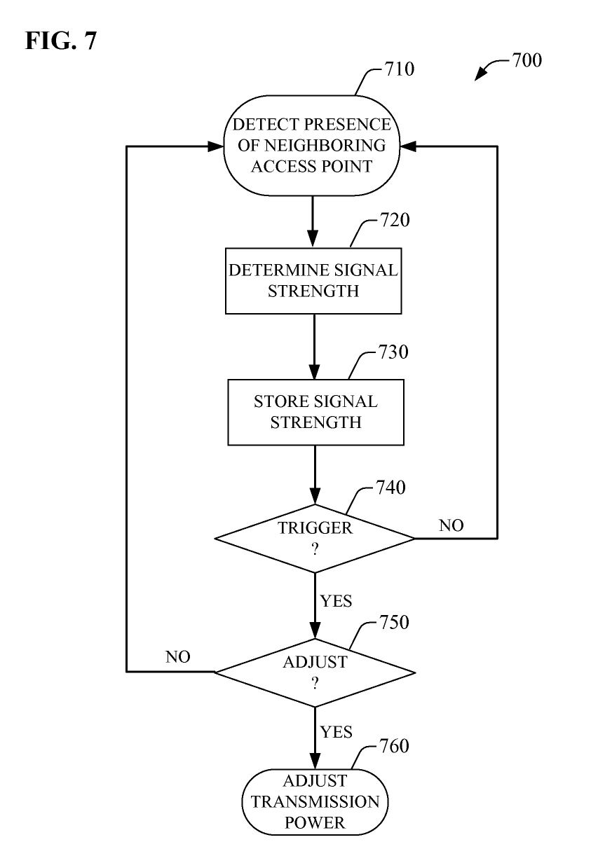

In FIG. 7, a flow chart is provided illustrating an exemplary methodology for varying the transmission power of an access point from sensory data. As illustrated, process 700 begins at step 710 where the presence of neighboring access points is detected. Here, it should be noted that specialized hardware for sensing such received power may be needed. Sensory data obtained from step 710 may then be processed at step 720 to determine the signal strength (i.e., received power) of the access point that transmitted the detected signal. The signal strength is then stored in memory at step 730.

At step 740, the access point may then include a trigger mechanism for determining whether to perform a power adjustment. For instance, if power adjustments were programmed to only occur at a particular time each day, process 700 may simply log all signal strengths received in the day and adjust its transmission power based on the “average” received power for the day. The trigger at step 740 may also be a function of the magnitude of the received power, wherein a power adjustment only occurs if such magnitude exceeds a threshold. In another embodiment, process 700 may automatically perform an adjustment prior to making any transmission.

Depending on the particular triggering mechanism, process 700 may thus either loop back to detecting neighboring access points at step 710, or proceed to step 750 where an adjustment determination is made. If process 700 continues to step 750, it should be noted that determining whether an adjustment is necessary may also depend on the particular triggering mechanism. For instance, if the triggering mechanism was based on a received power exceeding a threshold, process 700 may be designed to make an adjustment every time the such threshold is exceeded. However, if the trigger was based on a particular time interval expiring, step 750 may have to determine whether the circumstances even warrant an adjustment (e.g., if no neighboring access points are detected, no adjustment may be necessary). Accordingly, if an adjustment is deemed necessary, the transmission power of the access point is subsequently adjusted at step 760. Otherwise, process 700 loop backs to detecting neighboring access points at step 710.

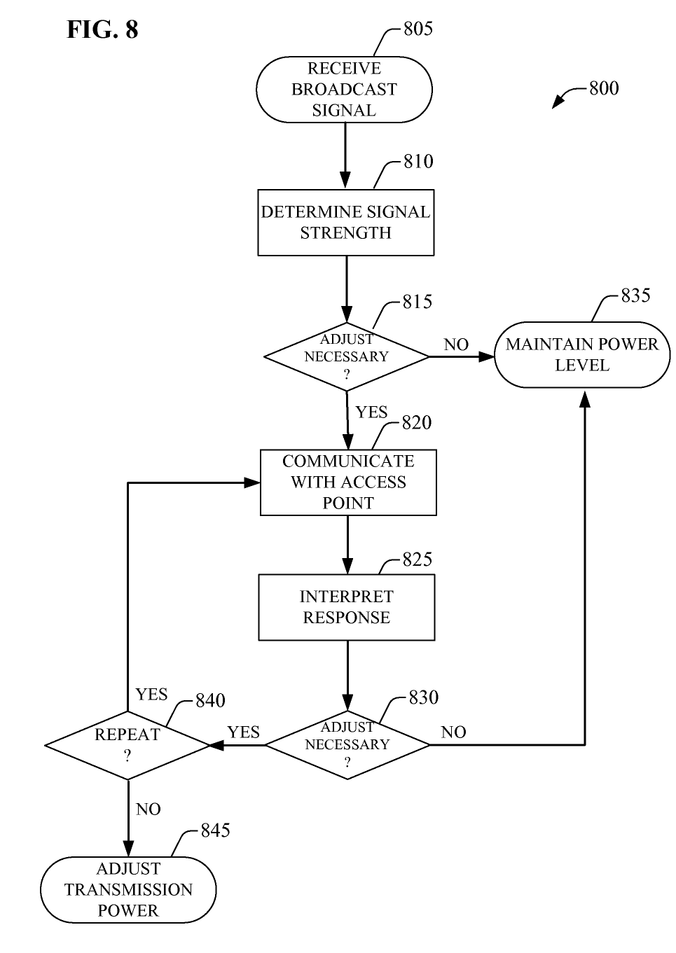

Referring next to FIG. 8, a flow chart is provided illustrating an exemplary methodology for varying the transmission power of an access point from a broadcast signal. As illustrated, process 800 begins at step 805 where the broadcast signal is received. Here, it should be appreciated that the broadcast signal may include any of a plurality of types of data. For instance, in an embodiment, the broadcast signal itself may include the transmission power parameters for the neighboring access point.

Once received, the broadcast signal is then utilized to ascertain the signal strength of the neighboring access point that transmitted the broadcast, at step 810. Moreover, the signal strength is obtained either from processing data included in the broadcast (e.g., by performing a simple computation based on the information regarding the location and transmission power of the broadcasting access point), or from sensory data gathered by the aforementioned specialized hardware.

Process 800 then proceeds to step 815 where an adjustment determination is made. Here, based on the signal strength obtained at step 810, it may be determined that an adjustment is not necessary (e.g., because the signal strength does not exceed a threshold), wherein process 800 would conclude by maintaining its current power level at step 835.

If, on the other hand, an adjustment is indeed necessary, process 800 may proceed to step 820 where the access point communicates directly with the neighboring access point. Such communication may include, for instance, a request for the neighboring access point to decrease its transmission power so as to avoid interference. At step 825, process 800 then continues with an interpretation of the response (or lack thereof) from the neighboring access point. Once the response is interpreted, a subsequent adjustment determination is made at step 830. Here, such determination may be based, for instance, on the neighboring access point indicating that it will indeed reduce its transmission power. If so, process 800 may continue to step 835 where the current power level is maintained. However, if it is determined that a power adjustment is still necessary, process 800 continues to step 840.

At step 840, a determination is made as to whether the neighboring access point should again be contacted. This may occur, for instance, when the neighboring access point does not respond to the initial contact. The neighboring access point may have also sent a “counter-offer”, which would require process 800 to provide a response to the counter-offer. Depending on the determination made at step 840, process 800 may thus engage in a subsequent communication with the neighboring access point at step 820, or adjust its transmission power at step 845.

In another exemplary embodiment, base stations with restricted associations are considered. Within such embodiment, a particular access point may vary its transmission power based on any combination of: the number of nearby base stations, the strength with which they are being received, and/or the level of restricted association afforded by the nearby base stations.

In one aspect, the first two features are readily determined by listening to the downlink beacons. The third feature may be partially learnable depending on the system implementation. Thus, in one embodiment, knowing which mobiles are allowed to associate with any base station helps set the cell boundaries of the current base station of interest. As an example, the same house could have multiple base stations (e.g., one in the lower level—basement, and another in the upper level)—and this will entail putting multiple base stations (with the same restricted association) in close proximity.

In general, varying power levels within the context of base stations having restricted associations may be achieved by the following exemplary method. First a list of base stations that share the same association list (or at least a significant subset) with the present base station may be identified. Next, for each base station in that list, the transmit power level is monitored based on beacon strength. In one embodiment, if transmit power is adaptively varying, the transmit power level may also be broadcast. Upon ascertaining the transmit power of each of its neighboring base stations, the transmit power of the present base station may be selected to be approximately half of the nearest base station in the list. In alternative embodiments, with respect to base stations that are nearby but do not share the association list, for example, it should be noted that an interference management technique based on spectrum reuse may also be utilized.

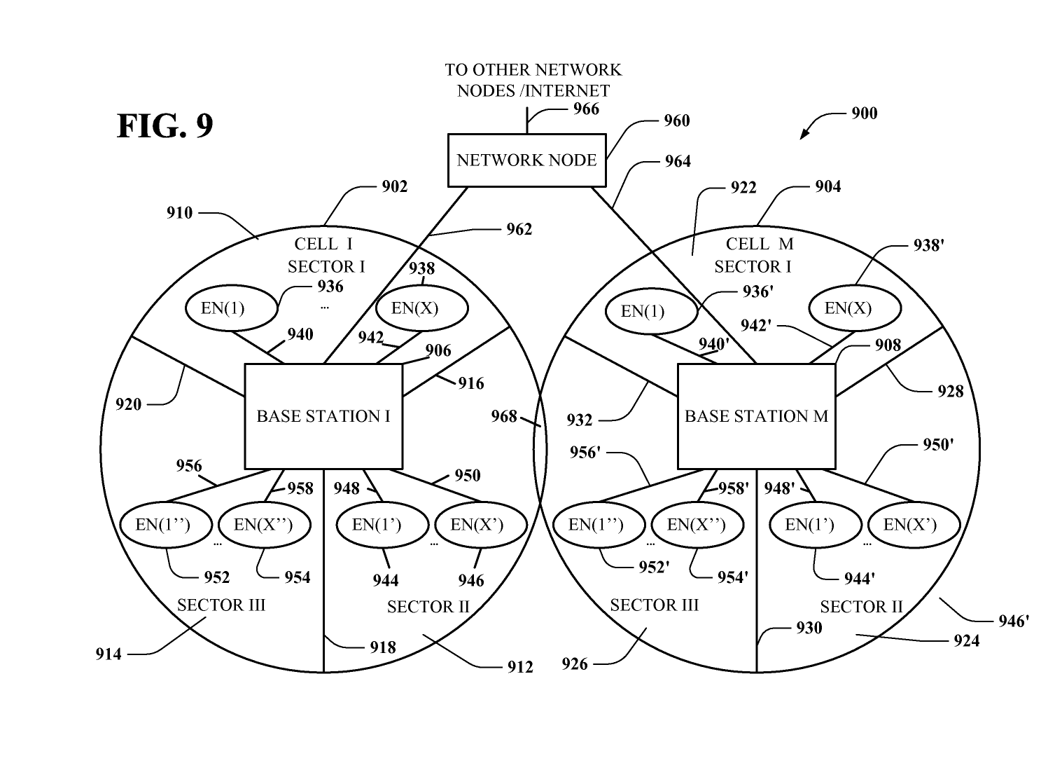

Referring next to FIG. 9, an exemplary communication system 900 implemented in accordance with various aspects is provided including multiple cells: cell I 902, cell M 904. Here, it should be noted that neighboring cells 902, 904 overlap slightly, as indicated by cell boundary region 968, thereby creating potential for signal interference between signals transmitted by base stations in neighboring cells. Each cell 902, 904 of system 900 includes three sectors. Cells which have not been subdivided into multiple sectors (N=1), cells with two sectors (N=2) and cells with more than 3 sectors (N>3) are also possible in accordance with various aspects. Cell 902 includes a first sector, sector I 910, a second sector, sector II 912, and a third sector, sector III 914. Each sector 910, 912, 914 has two sector boundary regions; each boundary region is shared between two adjacent sectors.

Sector boundary regions provide potential for signal interference between signals transmitted by base stations in neighboring sectors. Line 916 represents a sector boundary region between sector I 910 and sector II 912; line 918 represents a sector boundary region between sector II 912 and sector III 914; line 920 represents a sector boundary region between sector III 914 and sector 1 910. Similarly, cell M 904 includes a first sector, sector I 922, a second sector, sector II 924, and a third sector, sector III 926. Line 928 represents a sector boundary region between sector I 922 and sector II 924; line 930 represents a sector boundary region between sector II 924 and sector III 926; line 932 represents a boundary region between sector III 926 and sector I 922. Cell I 902 includes a base station (BS), base station I 906, and a plurality of end nodes (ENs) in each sector 910, 912, 914. Sector I 910 includes EN(1) 936 and EN(X) 938 coupled to BS 906 via wireless links 940, 942, respectively; sector II 912 includes EN(1′) 944 and EN(X′) 946 coupled to BS 906 via wireless links 948, 950, respectively; sector III 914 includes EN(1″) 952 and EN(X″) 954 coupled to BS 906 via wireless links 956, 958, respectively. Similarly, cell M 904 includes base station M 908, and a plurality of end nodes (ENs) in each sector 922, 924, 926. Sector I 922 includes EN(1) 936′ and EN(X) 938′ coupled to BS M 908 via wireless links 940′, 942′, respectively; sector II 924 includes EN(1′) 944′ and EN(X′) 946′ coupled to BS M 908 via wireless links 948′, 950′, respectively; sector 3 926 includes EN(1″) 952′ and EN(X″) 954′ coupled to BS 908 via wireless links 956′, 958′, respectively.

System 900 also includes a network node 960 which is coupled to BS I 906 and BS M 908 via network links 962, 964, respectively. Network node 960 is also coupled to other network nodes, e.g., other base stations, AAA server nodes, intermediate nodes, routers, etc. and the Internet via network link 966. Network links 962, 964, 966 may be, e.g., fiber optic cables. Each end node, e.g. EN 1 936 may be a wireless terminal including a transmitter as well as a receiver. The wireless terminals, e.g. EN(1) 936 may move through system 900 and may communicate via wireless links with the base station in the cell in which the EN is currently located. The wireless terminals, (WTs), e.g. EN(1) 936, may communicate with peer nodes, e.g., other WTs in system 900 or outside system 900 via a base station, e.g. BS 906, and/or network node 960. WTs, e.g., EN(1) 936 may be mobile communications devices such as cell phones, personal data assistants with wireless modems, etc. Respective base stations perform tone subset allocation using a different method for the strip-symbol periods, from the method employed for allocating tones and determining tone hopping in the rest symbol periods, e.g., non strip-symbol periods. The wireless terminals use the tone subset allocation method along with information received from the base station, e.g., base station slope ID, sector ID information, to determine tones that they can employ to receive data and information at specific strip-symbol periods. The tone subset allocation sequence is constructed, in accordance with various aspects to spread inter-sector and inter-cell interference across respective tones. Although the subject system was described primarily within the context of cellular mode, it is to be appreciated that a plurality of modes may be available and employable in accordance with aspects described herein.

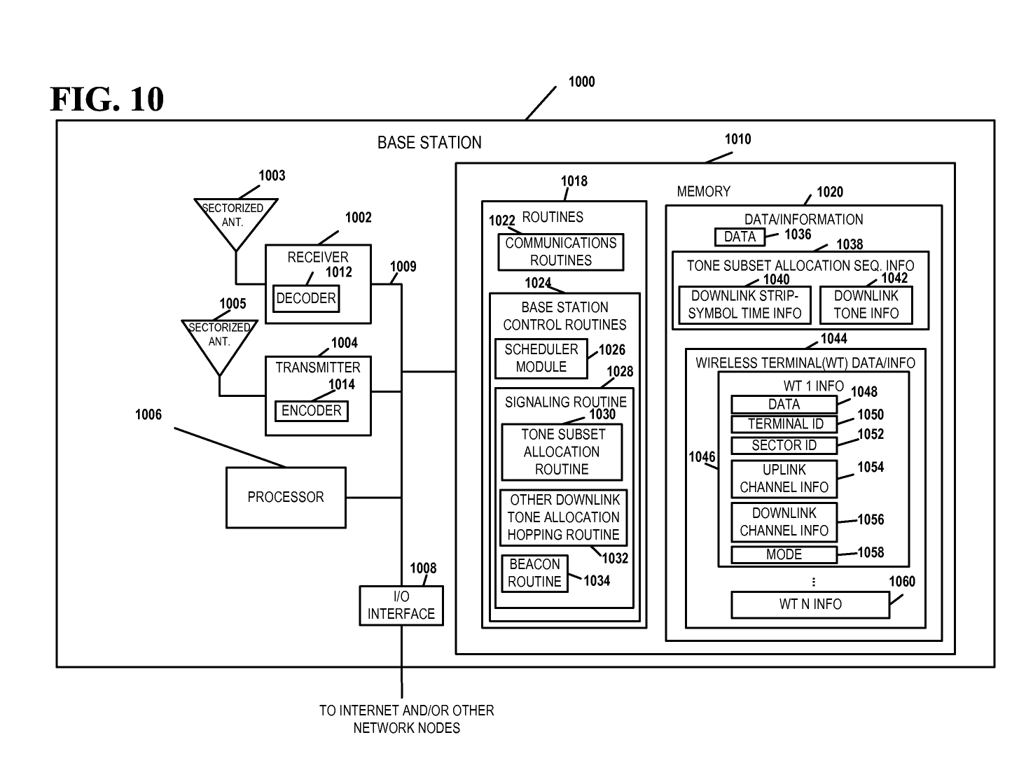

FIG. 10 illustrates an example base station 1000 in accordance with various aspects. Base station 1000 implements tone subset allocation sequences, with different tone subset allocation sequences generated for respective different sector types of the cell. Base station 1000 may be used as any one of base stations 906, 908 of the system 900 of FIG. 9. The base station 1000 includes a receiver 1002, a transmitter 1004, a processor 1006, e.g., CPU, an input/output interface 1008 and memory 1010 coupled together by a bus 1009 over which various elements 1002, 1004, 1006, 1008, and 1010 may interchange data and information.

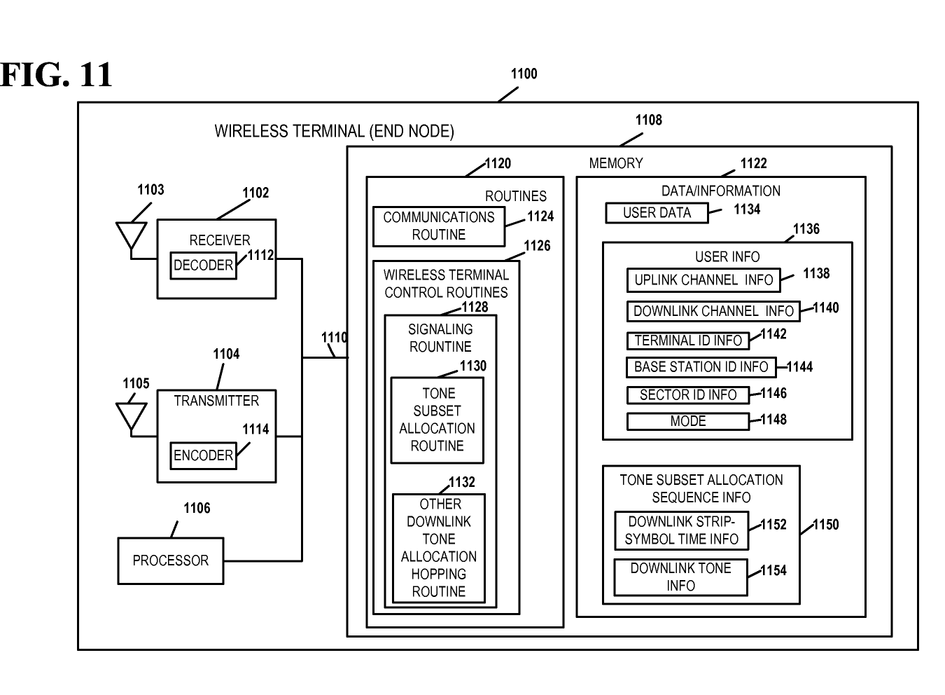

Sectorized antenna 1003 coupled to receiver 1002 is used for receiving data and other signals, e.g., channel reports, from wireless terminals transmissions from each sector within the base station's cell. Sectorized antenna 1005 coupled to transmitter 1004 is used for transmitting data and other signals, e.g., control signals, pilot signal, beacon signals, etc. to wireless terminals 1100 (see FIG. 11) within each sector of the base station's cell. In various aspects, base station 1000 may employ multiple receivers 1002 and multiple transmitters 1004, e.g., an individual receivers 1002 for each sector and an individual transmitter 1004 for each sector. Processor 1006, may be, e.g., a general purpose central processing unit (CPU). Processor 1006 controls operation of base station 1000 under direction of one or more routines 1018 stored in memory 1010 and implements the methods. I/O interface 1008 provides a connection to other network nodes, coupling the BS 1000 to other base stations, access routers, AAA server nodes, etc., other networks, and the Internet. Memory 1010 includes routines 1018 and data/information 1020.

Data/information 1020 includes data 1036, tone subset allocation sequence information 1038 including downlink strip-symbol time information 1040 and downlink tone information 1042, and wireless terminal (WT) data/info 1044 including a plurality of sets of WT information: WT 1 info 1046 and WT N info 1060. Each set of WT info, e.g., WT 1 info 1046 includes data 1048, terminal ID 1050, sector ID 1052, uplink channel information 1054, downlink channel information 1056, and mode information 1058.

Routines 1018 include communications routines 1022 and base station control routines 1024. Base station control routines 1024 includes a scheduler module 1026 and signaling routines 1028 including a tone subset allocation routine 1030 for strip-symbol periods, other downlink tone allocation hopping routine 1032 for the rest of symbol periods, e.g., non strip-symbol periods, and a beacon routine 1034.

Data 1036 includes data to be transmitted that will be sent to encoder 1014 of transmitter 1004 for encoding prior to transmission to WTs, and received data from WTs that has been processed through decoder 1012 of receiver 1002 following reception. Downlink strip-symbol time information 1040 includes the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone information 1042 includes information including a carrier frequency assigned to the base station 1000, the number and frequency of tones, and the set of tone subsets to be allocated to the strip-symbol periods, and other cell and sector specific values such as slope, slope index and sector type.

Data 1048 may include data that WT1 1100 has received from a peer node, data that WT 1 1100 desires to be transmitted to a peer node, and downlink channel quality report feedback information. Terminal ID 1050 is a base station 1000 assigned ID that identifies WT 1 1100. Sector ID 1052 includes information identifying the sector in which WT1 1100 is operating. Sector ID 1052 can be used, for example, to determine the sector type. Uplink channel information 1054 includes information identifying channel segments that have been allocated by scheduler 1026 for WT1 1100 to use, e.g., uplink traffic channel segments for data, dedicated uplink control channels for requests, power control, timing control, etc. Each uplink channel assigned to WT1 1100 includes one or more logical tones, each logical tone following an uplink hopping sequence. Downlink channel information 1056 includes information identifying channel segments that have been allocated by scheduler 1026 to carry data and/or information to WT1 1100, e.g., downlink traffic channel segments for user data. Each downlink channel assigned to WT1 1100 includes one or more logical tones, each following a downlink hopping sequence. Mode information 1058 includes information identifying the state of operation of WT1 1100, e.g. sleep, hold, on.

Communications routines 1022 control the base station 1000 to perform various communications operations and implement various communications protocols. Base station control routines 1024 are used to control the base station 1000 to perform basic base station functional tasks, e.g., signal generation and reception, scheduling, and to implement the steps of the method of some aspects including transmitting signals to wireless terminals using the tone subset allocation sequences during the strip-symbol periods.

Signaling routine 1028 controls the operation of receiver 1002 with its decoder 1012 and transmitter 1004 with its encoder 1014. The signaling routine 1028 is responsible controlling the generation of transmitted data 1036 and control information. Tone subset allocation routine 1030 constructs the tone subset to be used in a strip-symbol period using the method of the aspect and using data/info 1020 including downlink strip-symbol time info 1040 and sector ID 1052. The downlink tone subset allocation sequences will be different for each sector type in a cell and different for adjacent cells. The WTs 1100 receive the signals in the strip-symbol periods in accordance with the downlink tone subset allocation sequences; the base station 1000 uses the same downlink tone subset allocation sequences in order to generate the transmitted signals. Other downlink tone allocation hopping routine 1032 constructs downlink tone hopping sequences, using information including downlink tone information 1042, and downlink channel information 1056, for the symbol periods other than the strip-symbol periods. The downlink data tone hopping sequences are synchronized across the sectors of a cell. Beacon routine 1034 controls the transmission of a beacon signal, e.g., a signal of relatively high power signal concentrated on one or a few tones, which may be used for synchronization purposes, e.g., to synchronize the frame timing structure of the downlink signal and therefore the tone subset allocation sequence with respect to an ultra-slot boundary.

FIG. 11 illustrates an example wireless terminal (end node) 1100 which can be used as any one of the wireless terminals (end nodes), e.g., EN(1) 936, of the system 900 shown in FIG. 9. Wireless terminal 1100 implements the tone subset allocation sequences. The wireless terminal 1100 includes a receiver 1102 including a decoder 1112, a transmitter 1104 including an encoder 1114, a processor 1106, and memory 1108 which are coupled together by a bus 1110 over which the various elements 1102, 1104, 1106, 1108 can interchange data and information. An antenna 1103 used for receiving signals from a base station (and/or a disparate wireless terminal) is coupled to receiver 1102. An antenna 1105 used for transmitting signals, e.g., to a base station (and/or a disparate wireless terminal) is coupled to transmitter 1104.

The processor 1106, e.g., a CPU controls the operation of the wireless terminal 1100 and implements methods by executing routines 1120 and using data/information 1122 in memory 1108.

Data/information 1122 includes user data 1134, user information 1136, and tone subset allocation sequence information 1150. User data 1134 may include data, intended for a peer node, which will be routed to encoder 1114 for encoding prior to transmission by transmitter 1104 to a base station, and data received from the base station which has been processed by the decoder 1112 in receiver 1102. User information 1136 includes uplink channel information 1138, downlink channel information 1140, terminal ID information 1142, base station ID information 1144, sector ID information 1146, and mode information 1148. Uplink channel information 1138 includes information identifying uplink channels segments that have been assigned by a base station for wireless terminal 1100 to use when transmitting to the base station. Uplink channels may include uplink traffic channels, dedicated uplink control channels, e.g., request channels, power control channels and timing control channels. Each uplink channel includes one or more logic tones, each logical tone following an uplink tone hopping sequence. The uplink hopping sequences are different between each sector type of a cell and between adjacent cells. Downlink channel information 1140 includes information identifying downlink channel segments that have been assigned by a base station to WT 1100 for use when the base station is transmitting data/information to WT 1100. Downlink channels may include downlink traffic channels and assignment channels, each downlink channel including one or more logical tone, each logical tone following a downlink hopping sequence, which is synchronized between each sector of the cell.

User info 1136 also includes terminal ID information 1142, which is a base station-assigned identification, base station ID information 1144 which identifies the specific base station that WT has established communications with, and sector ID info 1146 which identifies the specific sector of the cell where WT 1100 is presently located. Base station ID 1144 provides a cell slope value and sector ID info 1146 provides a sector index type; the cell slope value and sector index type may be used to derive tone hopping sequences. Mode information 1148 also included in user info 1136 identifies whether the WT 1100 is in sleep mode, hold mode, or on mode.

Tone subset allocation sequence information 1150 includes downlink strip-symbol time information 1152 and downlink tone information 1154. Downlink strip-symbol time information 1152 include the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone info 1154 includes information including a carrier frequency assigned to the base station, the number and frequency of tones, and the set of tone subsets to be allocated to the strip-symbol periods, and other cell and sector specific values such as slope, slope index and sector type.

Routines 1120 include communications routines 1124 and wireless terminal control routines 1126. Communications routines 1124 control the various communications protocols used by WT 1100. Wireless terminal control routines 1126 controls basic wireless terminal 1100 functionality including the control of the receiver 1102 and transmitter 1104. Wireless terminal control routines 1126 include the signaling routine 1128. The signaling routine 1128 includes a tone subset allocation routine 1130 for the strip-symbol periods and an other downlink tone allocation hopping routine 1132 for the rest of symbol periods, e.g., non strip-symbol periods. Tone subset allocation routine 1130 uses user data/info 1122 including downlink channel information 1140, base station ID info 1144, e.g., slope index and sector type, and downlink tone information 1154 in order to generate the downlink tone subset allocation sequences in accordance with some aspects and process received data transmitted from the base station. Other downlink tone allocation hopping routine 1130 constructs downlink tone hopping sequences, using information including downlink tone information 1154, and downlink channel information 1140, for the symbol periods other than the strip-symbol periods. Tone subset allocation routine 1130, when executed by processor 1106, is used to determine when and on which tones the wireless terminal 1100 is to receive one or more strip-symbol signals from the base station 900. The uplink tone allocation hopping routine 1130 uses a tone subset allocation function, along with information received from the base station, to determine the tones in which it should transmit on.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

When the embodiments are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A method for facilitating power control in an access point within a wireless environment, comprising:
detecting a presence of at least one neighboring access point, the at least one neighboring access point being within radio reach of the access point;
ascertaining a neighboring signal strength for the at least one neighboring access point, the neighboring signal strength being a function of a neighboring transmission power associated with transmitting a signal from the at least one neighboring access point; and
varying an internal transmission power as a function of the neighboring signal strength, the internal transmission power associated with transmitting a signal from the access point.

2. The method of claim 1, the detecting step further comprising receiving a broadcast signal.

3. The method of claim 2, the broadcast signal including an indication of the neighboring transmission power and a location for the at least one neighboring access point, the ascertaining step further comprising approximating the neighboring signal strength as a function of the indication of the neighboring transmission power and the location for the at least one neighboring access point.

4. The method of claim 1, the detecting step further comprising detecting a received power, the received power corresponding to an amount of power detected at the access point from a signal originating from the at least one neighboring access point, the ascertaining step further comprising ascertaining the neighboring signal strength as a function of the received power.

5. The method of claim 1, the varying step further comprising performing the varying step according to a fixed time interval.

6. The method of claim 1, the varying step further comprising performing the varying step prior to each of a plurality of signal transmissions from the access point.

7. The method of claim 1, the ascertaining step further comprising determining whether the neighboring signal strength exceeds a threshold, the varying step further comprising performing the varying step only if the neighboring signal strength exceeds the threshold.

8. The method of claim 1 further comprising transmitting a message to the at least one neighboring access point, the message including a request to decrease the neighboring transmission power.

9. The method of claim 8 further comprising receiving a response message from the at least one neighboring access point, the varying step further comprising varying the internal transmission power as a function of the response message.

10. A system for facilitating power control in an access point within a wireless environment, comprising:
an interface component, the interface component configured to determine the presence of at least one neighboring access point, the at least one neighboring access point being accessible to the access point via a radio communication;
a processing component, the processing component coupled to the interface component and configured to execute computer-readable instructions, the instructions including instructions for determining a neighboring signal strength for the at least one neighboring access point, the neighboring signal strength being proportional to a neighboring transmission power associated with transmitting a signal from the at least one neighboring access point;
a memory component, the memory component coupled to the processor component and configured to store the computer-readable instructions; and
a power control component, the power control component coupled to the processor component and configured to adjust an internal transmission power as a function of the neighboring signal strength, the internal transmission power being an amount of power necessary to transmit a signal from the access point.

11. The system of claim 10, the interface component further configured to receive a broadcast signal.

12. The system of claim 11, the broadcast signal including an indication of the neighboring transmission power and a location for the at least one neighboring access point, the processor further configured to execute instructions for estimating the neighboring signal strength as a function of the indication of the neighboring transmission power and the location for the at least one neighboring access point.

13. The system of claim 10, the interface component further configured to detect a received power, the received power corresponding to an amount of power detected at the access point from a signal originating from the at least one neighboring access point, the processor further configured to execute instructions for determining the neighboring signal strength as a function of the received power.

14. The system of claim 10, the power control component further configured to adjust the internal transmission power after a fixed time interval.

15. The system of claim 10, the power control component further configured to adjust the internal transmission power prior to each of a plurality of signal transmissions from the access point.

16. The system of claim 10, the processor further configured to execute instructions for determining whether the neighboring signal strength exceeds a threshold, the power control component further configured to adjust the internal transmission power only if the neighboring signal strength exceeds the threshold.

17. The system of claim 10, the interface component further configured to transmit a message to the at least one neighboring access point, the message including a request to decrease the neighboring transmission power.

18. The system of claim 17, the interface component further configured to receive a response message from the at least one neighboring access point, the power control component further configured to adjust the internal transmission power as a function of the response message.

19. At least one processor configured to facilitate power control in an access point, comprising:
a first module for detecting a presence of at least one neighboring access point, the at least one neighboring access point being within radio reach of the access point;
a second module for ascertaining a neighboring signal strength for the at least one neighboring access point, the neighboring signal strength being a function of a neighboring transmission power associated with transmitting a signal from the at least one neighboring access point; and
a third module for varying an internal transmission power as a function of the neighboring signal strength, the internal transmission power associated with transmitting a signal from the access point.

20. A computer program product, comprising:
a computer-readable medium comprising:
a first set of codes for causing a computer to detect a presence of at least one neighboring access point, the at least one neighboring access point being within radio reach of the access point;
a second set of codes for causing the computer to ascertain a neighboring signal strength for the at least one neighboring access point, the neighboring signal strength being a function of a neighboring transmission power associated with transmitting a signal from the at least one neighboring access point; and
a third set of codes for causing the computer to vary an internal transmission power as a function of the neighboring signal strength, the internal transmission power associated with transmitting a signal from the access point.

21. An apparatus, comprising:
means for detecting a presence of at least one neighboring access point, the at least one neighboring access point being within radio reach of the access point;
means for ascertaining a neighboring signal strength for the at least one neighboring access point, the neighboring signal strength being a function of a neighboring transmission power associated with transmitting a signal from the at least one neighboring access point; and
means for varying an internal transmission power as a function of the neighboring signal strength, the internal transmission power associated with transmitting a signal from the access point.
